(19) United States
(12) Patent Application Publication
(10) Pub. No.: US 2020/0354944 A1
(43) Pub. Date: Nov. 12, 2020

(54) TOOL FOR CLEANING A DRAIN

(71) Applicant: Patrick GWEN, Houston, TX (US)

(72) Inventor: Patrick GWEN, Houston, TX (US)

(21) Appl. No.: 16/409,839

(22) Filed: May 12, 2019

(51) Int. Cl. E03F 9/00; B25G 1/10; B08B 9/045

(52) U.S. Cl. CPC E03F 9/005; B08B 9/045; B25G 1/102

(57) ABSTRACT

A tool for cleaning a drain includes a handle, a shaft, an auger head, and a sleeve. The handle includes a core, a crank, and a grip. The core defines a tool axis along the length of the tool. The crank is made integral with the core and extends radially from the core and the tool axis. The grip extends orthogonally from the crank and parallel to the core. The grip turns the crank to rotate the auger head relative to the sleeve, when the sleeve is held in place. The auger head at the end of the shaft is made integral with the shaft and has an elongated and undulated shape. The auger head includes a plurality of segments, and each segment has a curved surface, and there are barbs on a respective curved surface.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a tool for cleaning a drain. More particularly, the present invention relates to a tool for manually removing a clog or blockage in a plumbing pipe. The present invention further relates to a tool for clearing a drain by insertion and withdrawal of the tool into a pipe.

### 2. Description of Related Art Including Information Disclosed Under 37 CFR 1.97 and 37 CFR 1.98

Clogged drains can lead to messy and embarrassing situations. Depending upon the severity of the clog, there are a variety of mechanical implements that can be used to clear drains. A plunger is the most common tool used to unclog a blockage in a pipe. The plunger includes a shaft and a rubber cup at one end of the shaft. The free end of the shaft is the handle, used to place the plunger into position. The cup is positioned to cover the mouth of the drain in the water. Using the handle, the cup is pushed towards the drain. Air in the cup is forced into the drain to break the clog, while the cup is flattened. Using the handle again, the cup is pulled into its original shape, causing a vacuum. The vacuum also acts to loosen or break the clog. The air push and the vacuum pull work to clear the clog or other blockage in the drain. The plunger can be used on other drains besides a toilet drain, such as a sink drain or bath tub drain.

Another mechanical implement is the plumber's snake. This device is a flexible coil with an auger end, which is inserted into the drain to physically contact and displace the clog or blockage. The plumber's snake normally includes a coiled metal wire with an auger end and a crank attached to the metal wire. The crank rotates the metal wire as the plumber's snake enters the drain. The auger end has screw threads for boring into a clog. The combination of the rotation of the wire and the boring action of the auger end results in clearing a clog or blockage. There is the corkscrew action of the auger end to dig into the clog. The clog can be pulled out of the drain with the auger end anchored into the clog. There is the rupture of the clog with the snake drilling through the blockage, allowing some fluid to pass through the clog to break down the clog. Additionally, the mechanical action of rubbing the auger end and the coil against the blockage loosens and breaks the clog.

There are also rotating plumber's snakes.

Another mechanical tool is the auger strip, which includes an elongated flexible strip for insertion directly into the drain pipe. The strip has a length to physically reach the clog, and barbs are located along the length of the strip. The tip of the strip punctures, rubs, twists, and engages the clog for removal. The barbs scrap and impale the clog or other clogging fragments along the length of the drain pipe. The clog and fragments are snagged on the strip, and the strip is removed from the pipe by pulling the handle end from the drain. The snagged clog and fragments are removed from the pipe along with the strip.

The plunger is not always effective against all clogs, especially more serious clogs and blockages. The auger strip is not effective for sweeping the sides of the pipe, and the barbs are easily broken. The plumber's snake is difficult to effectively use, and some level of user skill is required for an effective removal of a clog. A rotating plumber's snake requires even more skill, since the user must both hold the tool and rotate the tool in order to be effective. There is a need for another type of device to be effective against clogs that cannot be cleared by either the prior art plunger, plumber's snake, or auger strip, while being easier to use, efficient and less costly than these known devices.

It is an object of the present invention to provide a tool for cleaning a drain.

It is another object of the present invention to provide embodiments of a drain cleaning tool with a specialized tip for breaking clogs.

It is another object of the present invention to provide embodiments of the drain cleaning tool with an undulated strip and barb elements.

It is another object of the present invention to provide embodiments of the drain cleaning tool with a stabilized sleeve to control rotation.

It is another object of the present invention to provide embodiments of the drain cleaning tool with a sleeve with a conical portion to lock position of the sleeve relative to the handle of the device.

These and other objectives and advantages of the present invention will become apparent from a reading of the attached specifications and appended claims.

### BRIEF SUMMARY OF THE INVENTION

Embodiments of the present invention include a tool for cleaning a drain. The tool can be inserted into a drain with a clog. Upon making contact with the clog, the tool is rotated to burrow into and break up the clog. The rotating action allows the barbs to engage more of the clog. Instead of the piercing or puncture action of the prior art, the present invention can reliably gouge the clog. The barbs can rotate to allow different angles of penetration into the clog, instead of the previous auger strips with a locked orientation of the barbs. The debris and clog material may wash freely through the pipe with the drain running without blockage.

The tool can include a handle comprised of a core defining a tool axis, a crank 40 being made integral with the core and extending radially from the core, and a grip extending orthogonally from the crank and parallel to the core. The tool also includes a shaft 60 made integral with the core and aligned with the core on the tool axis. Rotation of the core corresponds to rotation of the shaft. There is an auger head at the end of the shaft opposite the handle. The auger head has an elongated and undulated shape and is comprised of a plurality of segments. Each segment has a curved surface with barbs on the curved surface. The curved surfaces of adjacent segments alternate orientation between concave and convex. The present invention also includes a sleeve rotatably mounted around the core. The sleeve is stabilized on the core so that the shaft and auger head cannot move along the tool axis, when the sleeve is held in place. Holding the sleeve stabilizes the tool so that the shaft and auger head remain engaged with the clog instead of sliding along the tool axis and away from the clog.

Embodiments of the present invention include the core being comprised of a conical portion. The smaller diameter of the conical portion faces the shaft. The sleeve can be comprised of a tubular member with a conical section cooperative with the conical portion of the core. The conical section of the sleeve is cooperative to be rotatable around the conical portion of the core. In some embodiments, the conical section is comprised of collet fingers. The cooperative relationship at the connection of the core of the handle and the shaft stabilizes the sleeve. The sleeve cannot move laterally along the tool axis relative to the shaft. There is no sliding or slipping, even with rotating the shaft.

In other embodiments, the shaft can have a first shaft collar at the end of the shaft facing the handle. The shaft collar can also prevent displacement of the sleeve relative to the shaft. Alternatively, the crank of the handle can have a crank shoulder between the crank and the core. The crank shoulder has a shoulder diameter larger than a diameter of the core so that the sleeve is further stabilized from sliding or slipping relative to the shaft by the crank shoulder.

The present invention further includes the barbs on a respective curved surface in close proximity to each other. Each curved surface has a concave side and a convex side, so that the barbs can be placed on a concave side and/or convex side. The barbs rotated when the auger head rotates, and the auger head rotates when the shaft rotates. The barbs can burrow into a clog instead of only puncturing a clog.

Embodiments of the present invention include the method for cleaning a drain with the tool. The tool is inserted into a plumbing fixture and makes physical contact with a blockage. The sleeve is set in a locked position so as to hold the tool axis of the core in a fixed position relative to the sleeve. The handle is rotated around the tool axis, and the blockage is displaced by the auger head. The grip of the handle turns the crank so that the core rotates within the sleeve. The shaft and auger head rotate with the core so that the barbs have the burrowing action to remove the blockage.

### BRIEF DESCRIPTION OF THE SEVERAL VIEWS OF THE DRAWINGS

FIG. 1 is a front elevation view of an embodiment of the tool according to the present invention.

FIG. 2 is a side elevation view of an embodiment of the tool according to the present invention.

FIG. 3 is a perspective view of embodiments of the handle, shaft, and sleeve, according to the present invention.

FIG. 4 is exploded perspective view of embodiments of the handle, shaft, and sleeve, according to the present invention.

FIG. 5 is a sectional of embodiments of the handle, shaft, and sleeve, according to the present invention.

FIG. 6 is a perspective view of embodiments of the shaft and auger head, according to the present invention.

### DETAILED DESCRIPTION OF THE INVENTION

A clog in a drain is difficult to physically remove. A tool must reach the location in the drain from outside the plumbing fixture. Once in contact, the tool has limited physical interaction with the clog. Usually, there is a poking or puncturing action by actuating the tool in and out of the drain. These pokes or jabs can gradually disintegrate the clog by dislodging portions of clog material. For rotating plumber's snakes, there can also be burrowing action by rotating the tool from outside the drain. The drilling or burrowing can dislodge clog materials resistant to pokes and jabs. In order for the burrowing action to be effective, the tool must not be moving in and out of the drain. There is a need for a forward pressure of the drilling or burrowing action in order to be effective. The tool 10 of the present invention can be inserted into a drain to reach a clog and actuated for both poking action and burrowing action with effective barbs and stabilized positioning for effective removal of the clog.

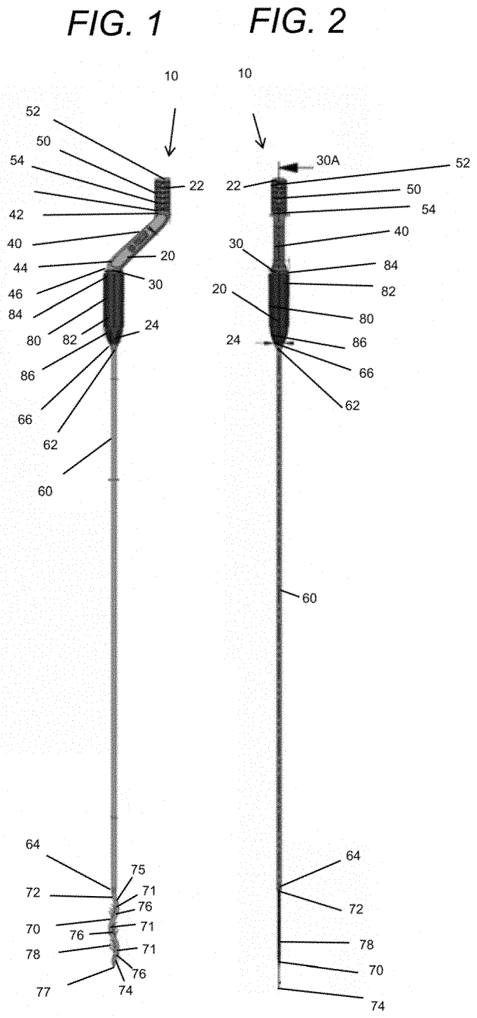

Referring to FIGS. 1 and 2, the tool 10 for cleaning a drain comprises a handle 20 having a first handle end 22 and a second handle end 24 opposite said first handle end, a shaft 60 having a first shaft end 62 and a second shaft end 64 opposite said first shaft end, an auger head 70 having a first auger end 72 and a second auger end 74 opposite said first auger end, and a sleeve 80 rotatably mounted around the handle 20. Embodiments of the tool 10 include the handle 20 being comprised of a core 30 defining a tool axis 30A and being positioned at the second handle end 24, a crank 40 being made integral with the core and extending radially from the core 30 and the tool axis 30A, and a grip 50 extending orthogonally from the crank 40 and parallel to the core 30. The grip 50 is positioned at the first handle end 22, and the crank 40 is between the grip 50 and the core 30.

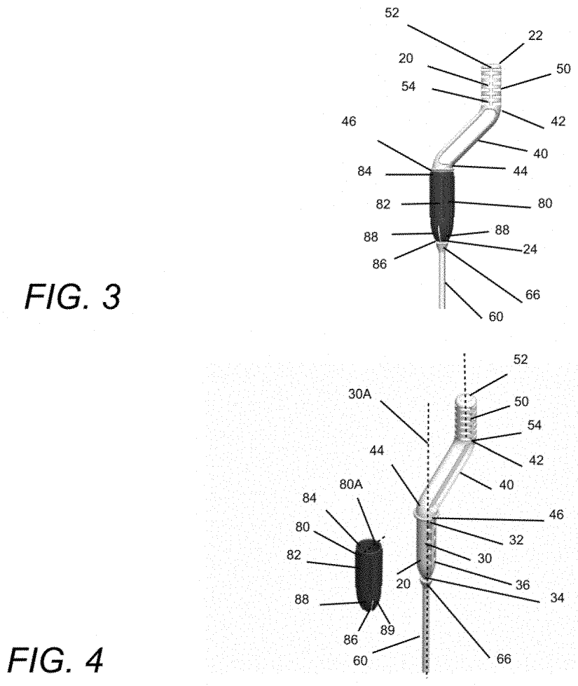

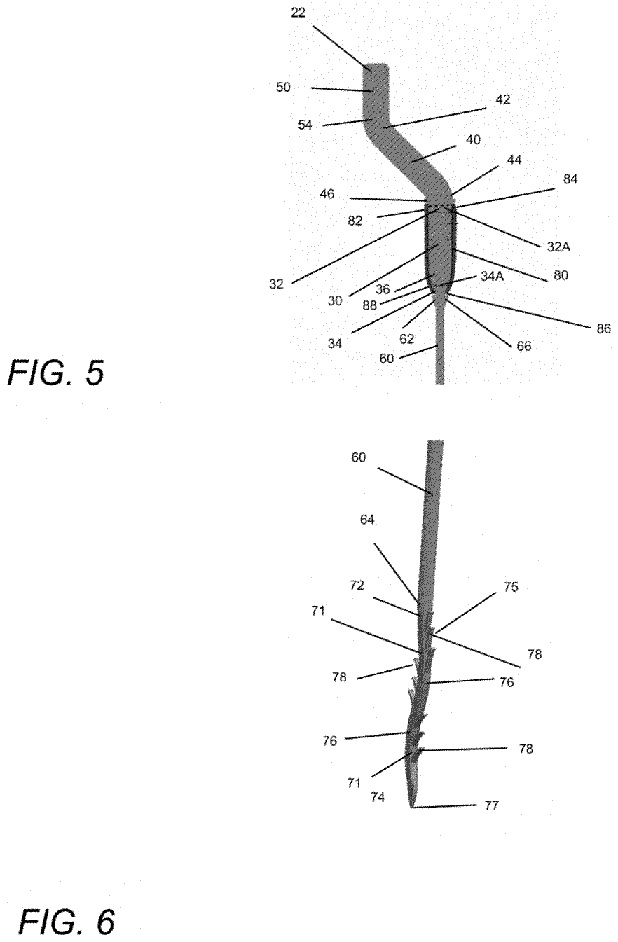

FIGS. 3-5 show embodiments of the handle 20, the shaft 60, and the sleeve 80. The shaft 60 is made integral with the core 30 of the handle 20. In particular, the first shaft end 62 is made integral with the handle 20 so that rotation of the core 30 corresponds to rotation of the shaft 60. The shaft 60 is aligned with the core 30 on the tool axis 30A. In embodiments of the handle 20, the core 30 has a first core end 32 and a second core end 34 opposite the first core end 32, and there is a conical portion 36 at the second core end 34. The second core end 34 defines the second handle end 24 away from crank 40. The second core end 34 engages the shaft 60. FIGS. 3-5 show the first core end 32 having a first core diameter 32A and the second core end having a second core diameter 34A. The second core diameter 34A is smaller than the first core diameter 32A. The orientation of the conical portion 36 has the smaller end facing the shaft 60.

In some embodiments, the sleeve 80 is comprised of a tubular member 82 having a first sleeve end 84 and a second sleeve end 86 opposite the first sleeve end 82 as shown in FIGS. 3-5. In particular, the second sleeve end 86 is comprised of a conical section 88 cooperative with the conical portion 36 of the core 30. The orientation of the conical portion 36 and the cooperative relationship with the sleeve 80 stabilizes the tool 10 for effective drilling or burrowing action. The tool 10 cannot slide through the sleeve 80 toward the clog in the drain, since the conical section 80 is cooperative with the conical portion 36 of the core 30. The handheld position by the user is more stable. The user does not have to worry about the tool 10 sliding forward toward the clog unless the user moves the sleeve 80 forward toward the clog.

FIGS. 3-5 also show the embodiment of the first shaft end 62 having a first shaft collar 66. The first shaft collar 66 has a first shaft diameter 66A greater than a diameter of the conical portion 36 at the second handle end 24. The first shaft diameter 66A is also larger than the sleeve 80. The first shaft collar 66 is another component to support the stabilized position of the sleeve 80. The first shaft collar 66 can back up of the conical portion 36 of the core 30 to hold position of the tool 10 from moving forward without also moving the sleeve 80 forward.

The embodiments of the crank 40 of the handle 20 are also shown in FIGS. 3-5. The crank 40 can have a first crank end 42 and a second crank end 44 opposite the first crank end 42. The second crank end is 44 is made integral with the grip 50, and the first crank end 42 is made integral with the core 30. Rotating the crank 40 corresponds to rotating the core 30 and the shaft 60. In this embodiment, the crank 40 further comprises a crank shoulder 46 between the crank 40 and the core 30. The crank shoulder 46 has a shoulder diameter 46A larger than a diameter of the sleeve 80. The crank shoulder 46 further stabilizes the position of the tool 10 relative to the sleeve 80. The crank shoulder 46 holds the position of the tool 10 from moving backward away from the clog. The handheld position by the user is further stabilized by the tool 10 not sliding backward through the sleeve 80.

Other embodiment of the sleeve 80 include the sleeve 80 being positioned around the core 30 by the crank shoulder 46 and the first shaft collar 66. These components can both stabilize the tool 10 for more effective drilling action in addition to the conical portion 36 of the core 30. FIGS. 3-5 show the conical section 88 being comprised of collet fingers 89. The conical section 88 remains cooperative to be rotatable around the conical portion 36 of the core. In some embodiments, the tubular member 82 can have a textured surface for gripping, and the outer surface of the tubular member 82 can have an ergonomic shape.

Embodiments of the present invention include the crank 40 extending radially and at an angle from the core 30. The crank 40 radially extends from the tool axis 30A defined by the core 30. The grip 50 is rotatable around the core 30 about the tool axis 30A. The grip 50 is parallel to the core 30 but offset so that rotating the grip 50 around the core 30 generates the rotation of the core 30 and shaft 60 relative to the sleeve 80. FIGS. 3-5 show the grip 50 having a first grip end 52 and a second grip end 54 being opposite the first grip end 52. The second grip end 54 is made integral with the crank 40, and the first grip end 52 can define the first handle end 22. The first grip end 52 is rotatable around the tool axis 30A by the crank 40. In some embodiment, the grip 50 can have a textured surface for gripping by the user, and the outer surface of the grip 50 can also have an ergonomic shape.

FIGS. 1, 2, and 6 show embodiments of the auger head 70. The first auger end 72 is made integral with the second shaft end 64 and has an elongated and undulated shape. The auger head 70 is comprised of a plurality of segments 71, and each segment has a curved surface 76. FIG. 6 shows a top segment 75 of the plurality of segments at the first auger end 72 connecting to the second shaft end 64 of the shaft 60. Each segment 71 is joined end to end to each other to form the auger head 70. The curved surfaces 76 of adjacent segments 71 alternate orientation. FIG. 6 shows the curved surfaces alternating concave and convex. Furthermore, each segment 71 is comprised of a plurality of barbs 78 on a respective curved surface 76. There can also be a tip 77 at the second auger end 74. The barbs 78 on a respective curved surface 76 are in close proximity to each other, and each curved surface 76 has both a concave side and a convex side. The embodiments show that the barbs 78 can be placed on a concave side or a convex side or both. The barbs 78 can be shielded by an adjacent convex side of an adjacent segment 71. FIGS. 1-2 show the alignment of the barbs 78 on the auger head 70. The barbs 78 are aligned along the length of the auger head 70, being generally parallel to the tool axis 30A. The poking action of the tool 10 functions as a known auger strip. The present invention adds the drilling action of the barbs 78 with the rotation of the tool 10 relative to the sleeve 80. The auger head 70 is no longer limited to jabbing or poking in a single plane along the tool axis 30A. There is more engagement of the barbs 78 to different parts of the clog so that the clog can be removed quicker and more efficiently.

Embodiments of the present invention further include the method for cleaning a drain with the tool 10. FIGS. 1-6 shows the method including the steps of inserting the tool 10 into a plumbing fixture, and making physical contact with a blockage. The physical contact includes abutting against a clog or even piercing the clog. The method includes setting the sleeve 80 in a locked position so as to hold the tool axis 30A in a fixed position relative to the sleeve 80. The user must hold the sleeve 80 firmly in position so that there is no movement forward or backward into the plumbing fixture. Then, the handle 20 is rotated around the tool axis 30A. The other hand of the user grasps the grip 50 and turns the crank 40 around the core 30 within the sleeve 80. The blockage is displaced by the auger head 70. If pierced, the rotation now drills into the blockage. If abutted, the user moves the sleeve 80 forward into the plumbing fixture in order to pierce the blockage. The barbs 78 engage the blockage to disintegrate more and more of the blockage. The shaft 60 and auger head 70 rotate with the core 30 so that the barbs 78 have the burrowing action to remove the blockage.

The present invention provides a tool for cleaning a drain. There is a specialized auger head with barbs to break the clogs. The undulated auger head has a piercing action to disintegrate the clog into smaller pieces. The barbs are oriented in a planar arrangement. Thus, the present invention also includes a stabilized sleeve to enable drilling action to more efficiently disintegrate the clog. The rotation of the barbs in the planar arrangement increases the destructive reach of the barbs to remove a clog. The tool includes a core with a conical portion to stabilize the position of the shaft and auger head relative to the sleeve. The shaft and auger head do not slip back and forth through the sleeve. The user can hold the tool steady for a reliable and controlled drilling action with pressure forward into the clog. Additionally, the first shaft collar and the crank shoulder restrict the movement of the sleeve relative to the shaft and auger head for further support of the position of the tool as held by the user. The present invention effectively stabilizes the sleeve so that the piercing action and the drilling action can be controlled by the user. There is no slippage through the sleeve. The user can more vigorously turn the crank with the grip without concern for accidental slipping of the shaft and auger head through the sleeve.

The foregoing disclosure and description of the invention is illustrative and explanatory thereof. Various changes in the details of the illustrated structures, construction and method can be made without departing from the true spirit of the invention.

I claim:

1. A tool for cleaning a drain, comprising:
a handle having a first handle end and a second handle end opposite said first handle end,
wherein said handle is comprised of:
a core defining a tool axis and being positioned at said second handle end;
a crank being made integral with said core and extending radially from said core and said tool axis; and
a grip extending orthogonally from said crank and parallel to said core, said grip being positioned at said first handle end, said crank being between said grip and said core;
a shaft being made integral with said core and having a first shaft end and a second shaft end opposite said first shaft end, said first shaft end being made integral with said handle, said shaft being aligned with said core on said tool axis;
an auger head having a first auger end and a second auger end opposite said first auger end, said first auger end being made integral with said second shaft end and having an elongated and undulated shape, said auger head being comprised of a plurality of segments,
wherein a top segment of said plurality of segments at said first auger end connects to said second shaft end of said shaft,
wherein each segment has a curved surface, each segment being joined end to end to each other to form said auger head,
wherein curved surfaces of adjacent segments alternate orientation, and
wherein each segment is comprised of a plurality of barbs on a respective curved surface; and
a sleeve having a sleeve diameter and being rotatably mounted around said core.

2. The tool, according to claim 1, said core having a first core end and a second core end opposite said first core end, said core being comprised of a conical portion at said second core end, said second handled end being defined by said second core end away from said crank.

3. The tool, according to claim 2, said first core end having a first core diameter, said second core end having a second core diameter, said second core diameter being smaller than said first core diameter.

4. The tool, according to claim 1, said crank having a first crank end and a second crank end opposite said first crank end, said second crank end being made integral with said grip, said first crank end being made integral with said core.

5. The tool, according to claim 4, further comprising: a crank shoulder between said crank and said core.

6. The tool, according to claim 5, said crank shoulder having a shoulder diameter larger than said sleeve diameter.

7. The tool, according to claim 1, said crank extending radially and at an angle from said core, said grip being rotatable around said core along said tool axis.

8. The tool, according to claim 1, said grip 50 having a first grip end and a second grip end being opposite said first grip end, said second grip end being made integral with said crank, said first handle end being defined by said first grip end.

9. The tool, according to claim 8, said first grip end being rotatable around said tool axis by said crank.

10. The tool, according to claim 1, said first shaft end having a first shaft collar.

11. The tool, according to claim 10, said first shaft collar having a first shaft diameter greater than said sleeve diameter.

12. The tool, according to claim 1, wherein said sleeve 80 is comprised of a tubular member having a first sleeve end and a second sleeve end opposite said first sleeve end.

13. The tool, according to claim 12, further comprising:
a crank shoulder between said crank and said core, said crank shoulder having a shoulder diameter larger than said sleeve diameter,
wherein said first shaft end has a first shaft collar, said first shaft collar having a first shaft diameter greater than a diameter of said conical portion at said second handle end, and
wherein said sleeve is positioned around said core and between said handle and said shaft by said crank shoulder and said first shaft collar.

14. The tool, according to claim 12, wherein said second sleeve end is comprised of a conical section being cooperative with said conical portion of said core.

15. The tool, according to claim 14, said conical section being comprised of collet fingers.

16. The tool, according to claim 1, wherein said second auger end is further comprised of a tip.

17. The tool, according to claim 16, wherein each curved surface has a concave side and a convex side, said barbs being placed on a corresponding concave side, said barbs being shielded by an adjacent convex side of an adjacent segment.

18. The tool, according to claim 16, wherein each curved surface has a concave side and a convex side, said barbs being placed on a corresponding convex side.

19. A method for cleaning a drain, the method comprising the steps of:
inserting a tool, according to claim 1, into a plumbing fixture;
making physical contact with a blockage;
setting said sleeve in a locked position so as to hold said tool on said tool axis in a fixed position relative to said sleeve;
rotating said handle around said tool axis; and
displacing said blockage with said auger head.

20. The method, according to claim 19, wherein the step of making physical contact is comprised of engaging said blockage with said barbs, and wherein the step of rotating said handle is comprised of turning said crank with said grip.
